(19) United States
(12) Patent Application Publication
(10) Pub. No.: US 2024/0150564 A1
(43) Pub. Date: May 9, 2024

(54) Ionomer Composition Containing Masterbatch and Glass Laminate Produced Using the Same

(71) Applicants: SK Innovation Co, Ltd., Seoul (KR); SK Geo Centric Co, Ltd., Seoul (KR)

(72) Inventors: Sang Yeup Lee, Daejeon (KR); Cristian Marro Bellot, Seoul (KR); Soon Min Kwon, Daejeon (KR)

(21) Appl. No.: 18/386,653

(22) Filed: Nov. 3, 2023

(30) Foreign Application Priority Data
Nov. 4, 2022 (KR) 10-2022-0145694

(51) Int. Cl. C08L 23/08; C08J 3/22

(52) U.S. Cl. CPC C08L 23/0876; C08J 3/226; C08K 2003/0818

(57) ABSTRACT

The present disclosure relates to an ionomer composition containing a masterbatch and a glass laminate produced using the same. The masterbatch may be obtained by melt-kneading a zinc ionomer and a coupling agent, such that a crosslinking side reaction, which has been a problem in the related art, may be effectively suppressed, and as a result, an ionomer composition and a glass laminate that have significantly improved transparency, processability, and an adhesive strength to glass may be produced.

### CROSS-REFERENCE TO RELATED APPLICATION

This application claims priority to Korean Patent Application No. 10-2022-0145694, filed Nov. 4, 2022, the disclosure of which is hereby incorporated by reference in its entirety.

### BACKGROUND OF THE INVENTION

### Field of the Invention

The following disclosure relates to an ionomer composition comprising a masterbatch and a glass laminate produced using the same.

### Description of Related Art

An ionomer is a thermoplastic plastic containing both a covalent bond and an ionic bond, and representative examples thereof include ethylene-based ionomers such as an ethylene-methacrylic acid copolymer or an ethylene-acrylic acid copolymer. In general, the ionomer is used in a food packaging film, a tray, a pouch, glass, and a container for adhesive and coating purposes.

In particular, an ionomer having excellent transparency is prepared by increasing a content of acrylic acid or methacrylic acid component in the ethylene-methacrylic acid copolymer or the ethylene-acrylic acid copolymer or increasing a degree of neutralization with a metal salt, and the prepared ionomer is also applied to transparent materials such as an intermediate layer of laminated glass, a solar cell encapsulation layer, and a transparent container. In addition, the transparency varies depending on the type of metal salt, and a sodium (Na) ionomer is mainly used as a highly transparent ionomer. However, since a sodium metal ion of the sodium ionomer exhibits a strong cohesive force and interacts with surrounding acrylic acid or methacrylic acid, there is a problem of poor adhesion to glass due to a small amount of excess acid groups.

In order to solve the above problem, when a silane coupling agent that improves adhesion to glass is added, an excessive crosslinking side reaction between the sodium ionomer and the coupling agent occurs, resulting in a significant decrease in melt flow index and an excessive increase in haze.

Meanwhile, a zinc (Zn) ionomer interacts with only a part of the surrounding acrylic acid or methacrylic acid depending on a determined acid value or coordination number, and as a result, more excess acid groups remain than the sodium ionomer. For this reason, the zinc ionomer may realize a stronger adhesive strength than the sodium ionomer not only to a glass plate but also to an aluminum foil, a metal surface, and components such as hydroxide and cellulose on a paper surface. However, transparency of the zinc ionomer is inferior to that of the sodium ionomer.

Therefore, there is a need for research and development on an ionomer composition having excellent transparency, processability, and adhesion to glass that may simultaneously realize the advantages of the sodium ionomer having excellent transparency and the advantages of the zinc ionomer having an excellent adhesive strength.

### SUMMARY OF THE INVENTION

An embodiment of the present disclosure is directed to providing an ionomer composition having excellent transparency, processability, and/or adhesion to glass by minimizing a crosslinking side reaction of a coupling agent, and a method of preparing the same.

Another embodiment of the present disclosure is directed to providing a glass laminate having excellent transparency and/or adhesion and a method of producing the same.

In order to solve the above problems, the present inventors have found that when a masterbatch was prepared by first mixing a zinc ionomer with a silane coupling agent, and then an ionomer composition comprising the masterbatch and a sodium ionomer was prepared, a crosslinking side reaction of the silane coupling agent was effectively suppressed, and a melt flow index and/or a haze, which had deteriorated rapidly in the related art, showed excellent values, and/or at the same time, an adhesive strength to glass was improved, thereby completing the present disclosure.

In one general aspect, an ionomer composition comprises a sodium ionomer; and a masterbatch comprising a zinc ionomer and a coupling agent, wherein the sodium ionomer is comprised in a higher content than the zinc ionomer.

According to some examples, the sodium ionomer and the zinc ionomer may be each independently selected from an ethyleneacrylic acid ionomer(s), an ethylene-methacrylic acid ionomer(s), or mixtures thereof.

According to some examples, the zinc ionomer may have a degree of neutralization with zinc metal of 5 to 50 mol %.

According to some examples, the sodium ionomer may have a degree of neutralization with sodium metal of 10 to 60 mol %.

According to some examples, a weight ratio of the sodium ionomer to the zinc ionomer may be 4:1 to 20:1.

According to some examples, the coupling agent may comprise an alkoxysilane-based compound.

According to some examples, the alkoxysilane-based compound may comprise an amino group and a C₁₋₅ alkoxy group.

According to some examples, the alkoxysilane-based compound may be one or a combination of two or more selected from aminopropyldimethoxymethylsilane, aminopropyldiethoxymethylsilane, aminopropyldimethoxyethylsilane, aminopropyldiethoxyethylsilane, aminopropyldimethoxypropylsilane, and aminopropyldiethoxypropylsilane.

According to some examples, the coupling agent may be comprised in an amount of 0.1 to 5 parts by weight with respect to 100 parts by weight of the zinc ionomer.

According to some examples, the masterbatch may be comprised in an amount of 5 to 30 parts by weight with respect to 100 parts by weight of the sodium ionomer.

According to some examples, the ionomer composition may have a melt flow index of 0.5 to 10 g/10 min when measured at a temperature of 190° C. and a load of 2.16 kg according to ASTM D1238.

According to some examples, the ionomer composition may be used for an intermediate layer of laminated glass.

According to some examples, the ionomer composition may have an adhesive strength to glass of 50 N/cm or more when measured at a thickness of 1 mm.

According to some examples, when the ionomer composition is in a form of a film having a thickness of 1 mm, the ionomer composition may have a haze of 0.7% or less when measured according to ASTM D1003.

In another general aspect, a glass laminate comprises a first glass; an intermediate layer provided on the first glass and formed using the ionomer composition; and a second glass provided on the intermediate layer.

In still another general aspect, a method of preparing an ionomer composition comprises: (a) preparing a masterbatch by melt-kneading a composition comprising a zinc ionomer and a coupling agent; and (b) melt-kneading a sodium ionomer and the masterbatch.

According to some examples, in step (a), the masterbatch may be in a state in which the coupling agent is uniformly dispersed inside the zinc ionomer.

According to some examples, a melt-kneading temperature in step (a) may be lower than a melt-kneading temperature in step (b).

Other features and aspects will be apparent from the following detailed description, the drawings, and the claims.

### DESCRIPTION OF THE INVENTION

Hereinafter, the present disclosure will be described in more detail. However, each of the following examples or exemplary embodiments are only reference examples for describing the present disclosure in detail, and the present disclosure is not limited thereto and may be implemented in various forms.

In addition, unless otherwise defined, all the technical terms and scientific terms have the same meanings as commonly understood by those skilled in the art to which the present disclosure pertains.

The terms used in the description of the present disclosure are merely used to effectively describe a specific exemplary embodiment, and are not intended to limit the present disclosure.

In addition, unless the context clearly indicates otherwise, singular forms, such as “a”, “an”, and “the”, used in the disclosure and the scope of the appended claims are intended to include plural forms.

In addition, unless explicitly described to the contrary, “comprising”, “including”, “having” or “containing” any components will be understood to imply further inclusion of other components rather than the exclusion of any other components.

In addition, the term (meth)acrylic acid used in the present specification may refer to methacrylic acid or acrylic acid.

For the purposes of this disclosure, unless otherwise indicated, all numbers expressing quantities of ingredients, reaction conditions, dimensions, physical characteristics, and so forth used in the disclosure and claims are to be understood as being modified in all instances by the term “about.” Unless indicated to the contrary, the numerical parameters set forth in the following disclosure and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

In addition, a numerical range used in the present specification may include upper and lower limits and all values within these limits, increments logically derived from a form and span of a defined range, all double limited values, and all possible combinations of the upper and lower limits in the numerical range defined in different forms. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Unless otherwise specifically defined in the present disclosure, values out of the numerical range that may occur due to experimental errors or rounded values also fall within the defined numerical range.

The term “ionomer” described in the present disclosure refers to a thermoplastic plastic containing both a covalent bond and an ionic bond, or a polymer comprising electrically neutral units and ionized units covalently bonded to the polymer backbone as pendant group moieties, a portion of pendant acid group(s) having been neutralized by a metal cation, such as sodium, zinc, and/or magnesium.

Non-limiting examples of ionomers comprise ethylene-based ionomers such as ethylene-methacrylic acid copolymer(s), ethylene-acrylic acid copolymer(s) or mixtures thereof.

Hereinafter, the present disclosure will be described in more detail.

In the related art, although additives such as a silane coupling agent were added to a sodium ionomer, which has excellent transparency but poor adhesion to glass or the like, to make up for the disadvantages, an excessive crosslinking side reaction occurred, resulting in rapid deterioration of processability, transparency, and molding quality.

In order to solve the above problems, in the present disclosure, the present inventors have devised a method of preparing a masterbatch by first mixing a zinc ionomer with a silane coupling agent, and then preparing an ionomer composition by adding the masterbatch to a sodium ionomer, and have found that a crosslinking side reaction of the silane coupling agent was effectively suppressed by this method, and the problems in the related art were effectively solved, and furthermore, excellent transparency and/or adhesion to glass were simultaneously realized, thereby completing the present disclosure.

The present disclosure provides an ionomer composition comprising a sodium ionomer; and a masterbatch comprising a zinc ionomer and a coupling agent. In some examples, the sodium ionomer is comprised in a higher content than the zinc ionomer.

According to some examples, the sodium ionomer and the zinc ionomer may be each independently ethylene-methacrylic acid copolymer(s), ethylene-acrylic acid copolymer(s) or mixtures thereof. The term “(meth)acrylic acid” described in the present disclosure may be acrylic acid and/or methacrylic acid.

According to some examples, the sodium ionomer may be a sodium-neutralized ethylene-(meth)acrylic acid ionomer. In some examples, the sodium-neutralized ethylene-(meth)acrylic acid ionomer may comprise a repeating unit of (meth)acrylic acid in an amount of 1 to 40 wt %, or 5 to 30 wt %, or 10 to 25 wt %.

In some examples, the sodium ionomer, or the sodium-neutralized ethylene-(meth)acrylic acid ionomer, may have a degree of neutralization with sodium metal of 5 to 70 mol %, or 10 to 60 mol %, or 20 to 50 mol %.

According to some examples, the sodium ionomer may have a melt flow index of 0.1 to 10 g/10 min., or 1 to 5 g/10 min., when measured at a temperature of 190° C. and a load of 2.16 kg according to ASTM D1238, but is not limited thereto.

According to some examples, when the sodium ionomer is in a form of a film having a thickness of 1 mm, the sodium ionomer may have a haze of 0.01 to 5%, or 0.1 to 2%, when measured according to ASTM D1003, but is not limited thereto.

According to some examples, the zinc ionomer may be a zinc-neutralized ethylene-(meth)acrylic acid ionomer. In some examples, the zinc-neutralized ethylene-(meth)acrylic acid ionomer may comprise a repeating unit of (meth)acrylic acid in an amount of 1 to 40 wt %, or 5 to 30 wt %, or 10 to 25 wt %.

According to some examples, the zinc ionomer, or zinc-neutralized ethylene-(meth)acrylic acid ionomer, may have a degree of neutralization with zinc metal of 5 to 50 mol %, or 10 to 40 mol %, or 15 to 30 mol %.

According to some examples, the zinc ionomer may have a melt flow index of 0.1 to 30 g/10 min., or 3 to 20 g/10 min., when measured at a temperature of 190° C. and a load of 2.16 kg according to ASTM D1238, but is not limited thereto.

According to some examples, when the zinc ionomer is in a form of a film having a thickness of 1 mm, the zinc ionomer may have a haze of 0.1 to 10%, or 0.1 to 5%, when measured according to ASTM D1003, but is not limited thereto.

According to some examples, the sodium ionomer is comprised in a higher content than the zinc ionomer, for example a weight ratio of the sodium ionomer to the zinc ionomer may be 2:1 to 100:1, or 4:1 to 50:1, or 9:1 to 30:1, or 4:1 to 20:1. In some examples, a weight ratio of the sodium metal of the sodium ionomer to the zinc metal of the zinc ionomer may be 5:1 to 100:1, or 5:1 to 70:1, or 7:1 to 40:1. In some examples, the sodium ionomer is comprised in a higher content than the zinc ionomer, such that transparency and an adhesive strength to glass may be further improved.

According to some examples, the coupling agent may comprise an alkoxysilane-based compound. In some examples, the alkoxysilane-based compound may comprise a C₁₋₅ alkoxy group or a C₁₋₃ alkoxy group, and may further comprise one or more functional groups selected from an amino group, an epoxy group, and/or a thiol group. In some examples, the alkoxysilane-based compound may be a compound comprising an amino group and/or a C₁₋₅ alkoxy group.

According to some examples, the alkoxysilane-based compound may be one or a combination of two or more selected from 3-aminopropyldimethoxymethylsilane, 3-aminopropyldiethoxymethylsilane, aminopropyldimethoxyethylsilane, aminopropyldiethoxyethylsilane, aminopropyldimethoxypropylsilane, and/or aminopropyldiethoxypropylsilane, or may be 3-aminopropyldiethoxymethylsilane.

According to some examples, the coupling agent may be comprised in an amount of 0.01 to 10 parts by weight, or 0.1 to 5 parts by weight, or 0.5 to 3 parts by weight, with respect to 100 parts by weight of the zinc ionomer. In addition, the coupling agent may be comprised in an amount of 0.005 to 1 part by weight, or 0.01 to 0.5 parts by weight, or 0.05 to 0.3 parts by weight, with respect to 100 parts by weight of the sodium ionomer.

According to some examples, the masterbatch may be comprised in an amount of 1 to 50 parts by weight, or 3 to 40 parts by weight, or 5 to 30 parts by weight, or 5 to 12 parts by weight, with respect to 100 parts by weight of the sodium ionomer.

According to some examples, the ionomer composition may further comprise one or more additives comprising an antioxidant(s), an ultraviolet absorber(s), a light stabilizer(s), an anti-blocking agent(s), a pigment(s), a dye(s), and/or a heat shielding material(s) (infrared absorber(s)), or a mixture thereof. These additives may be generally used without limitation as long as they are well known to those skilled in the art.

According to some examples, the ionomer composition may have a melt flow index of 0.5 to 10 g/10 min., or 0.8 to 7 g/10 min., or 1 to 5 g/10 min., when measured at a temperature of 190° C. and a load of 2.16 kg according to ASTM D1238. An ionomer composition according to the related art has a problem in that the melt flow index is rapidly reduced due to an excessive crosslinking side reaction, and on the other hand, the ionomer composition according to some examples of the present disclosure may realize excellent processability by solving this problem.

According to some examples, the ionomer composition may be widely applied in the field of transparent materials requiring transparency and/or adhesion to glass, such as an intermediate layer of laminated glass, an encapsulation layer of a solar cell, and/or a transparent container.

According to some examples, the ionomer composition may have a (glass) adhesive strength to glass of 50 N/cm or more, or 60 N/cm or more, or 70 N/cm or more, or 75 N/cm or more, when measured at a thickness of 1 mm, and an upper limit thereof is not particularly limited, and may be 200 N/cm or less. The ionomer composition according to some examples of the present disclosure may have an improved (glass) adhesive strength than that of a sodium ionomer alone.

According to some examples, when the ionomer composition is in a form of a film having a thickness of 1 mm, the ionomer composition may have a haze of 2% or less, or 1% or less, or 0.8% or less, or 0.7% or less, or 0.01 to 0.5%, when measured according to ASTM D1003. The ionomer composition according to some examples has an advantage that an increase in haze value may be effectively suppressed compared to the related art.

The present disclosure may provide an ionomer film produced using the ionomer composition described above. The ionomer film may have a thickness of 1 μm to 500 mm or 10 μm to 10 mm, but is not limited thereto.

The present disclosure may provide a glass laminate comprising: a first glass; an intermediate layer provided on the first glass and formed using the ionomer composition; and a second glass provided on the intermediate layer.

Commonly known types of glass may be used independently as the first glass and the second glass, a thickness of each of the first glass and the second glass is not particularly limited, and may be, for example, 1 mm to 50 cm. The first glass and the second glass may be each independently subjected to an additional treatment to have a surface with an improved adhesive strength.

The intermediate layer may be formed using the ionomer composition described above, and may exhibit excellent transparency and adhesion to glass. A thickness of the intermediate layer is not particularly limited, and may be, for example, 10 μm to 100 mm. The intermediate layer may be interposed between glasses and may serve to bond the glasses to each other.

The method of producing a glass laminate is not particularly limited, and may comprise interposing a film formed using the ionomer composition described above between the first glass and the second glass and then applying energy such as heat to adhere the film, but may be performed according to a commonly used or known method.

The present disclosure provides a method of preparing an ionomer composition, the method comprising: (a) preparing a masterbatch by melt-kneading a composition comprising a zinc ionomer and a coupling agent; and (b) melt-kneading a sodium ionomer and the masterbatch.

According to some examples, step (a) is a step of preparing a masterbatch comprising a zinc ionomer and a coupling agent, and may comprise melt-kneading a composition comprising a zinc ionomer and a coupling agent at a temperature of 100 to 250° C., or 120 to 200° C. Accordingly, the masterbatch is in a state in which the coupling agent is generally uniformly dispersed inside the zinc ionomer, and the coupling agent is not simply present on a part or surface of the zinc ionomer, but the zinc ionomer serves as a carrier for the coupling agent, thereby significantly improving dispersibility of the coupling agent. Furthermore, the zinc ionomer serves as a carrier for the coupling agent, such that an excessive crosslinking side reaction that may occur between the sodium ionomer and the coupling agent in the subsequent step (b) may be effectively suppressed. Through this, the ionomer composition according to some examples may simultaneously realize excellent transparency and/or adhesion (to glass). In addition, in the process of preparing a masterbatch, a commonly used or known method or a processing method such as extraction or injection may be used.

According to some examples, step (b) is a step of preparing an ionomer composition by mixing the masterbatch prepared in step (a) with a sodium ionomer, and in some examples may comprise melt-kneading the sodium ionomer and the masterbatch at a temperature of 130 to 300° C., or 150 to 280° C., or 180 to 250° C. In addition, in the process of preparing an ionomer composition, a commonly used or known method or a processing method such as extraction or injection may be used.

According to some examples, the melt-kneading temperature during the masterbatch preparation in step (a) may be lower than the melt-kneading temperature in step (b), a difference between these temperatures may be 10 to 150° C., or 15 to 120° C., or 20 to 80° C. Through this, an ionomer composition having further improved transparency may be prepared.

In addition, the method of preparing an ionomer composition may further comprise molding the prepared ionomer composition into a film or a sheet, and the molding may be performed by using a commonly used or known method or a processing method such as extraction or injection.

Hereinafter, the present disclosure will be described in more detail with reference to Example and Comparative Examples. However, the following Example and Comparative Examples are only examples for describing the present disclosure in more detail, and the present disclosure is not limited by the following Example and Comparative Examples.

Physical properties in the following Example and Comparative Examples were measured by the following methods.

[Methods for Evaluating Physical Properties]

1. Melt Flow Index (MFI) [g/10 min.]

A melt flow index (MFI) was measured at a temperature of 190° C. and a load of 2.16 kg according to ASTM D1238.

2. Haze [9 6]

A haze of the ionomer film (thickness: 1 mm) produced in Example or each of Comparative Examples was measured with a hazemeter (NDH-8000, manufactured by Nippon Denshoku industries Co., Ltd.) according to ASTM D1003.

3. Adhesive Strength [N/cm]

The ionomer film (thickness: 1 mm, width: 5 cm, length: 8 cm) produced in Example or each of Comparative Examples and a Teflon film were sequentially placed on a glass plate (width: 7 cm, length: 10 cm, thickness: 2 cm), and the films were pressurized in a vacuum lamination apparatus at a temperature of 125° C. and a pressure of 12.5 MPa for 30 minutes. Subsequently, the sample was taken out from the apparatus, the Teflon film of the produced glass laminate was removed and allowed to stand in an oven at 25° C. and 50 RH % for 24 hours, and then the ionomer film adhering to the glass plate was cut to have a width of 1 cm, thereby preparing a test sample. An adhesive strength between the glass plate and the ionomer film of the prepared sample was measured. UTM (INSTRON 5965) was used as a measuring apparatus, and the measurement was performed under conditions of T type (angle: 180°) and a peeling rate of 200 mm/min.

### Preparation of Masterbatch

### Preparation Example 1

A composition containing 3-aminopropyldiethoxymethylsilane in an amount of 1 part by weight with respect to 100 parts by weight of a zinc-neutralized ethylene acrylic acid ionomer (acrylic acid: 13.5 wt %, a degree of neutralization with zinc: 15 mol %) was added to a single-screw reaction extruder, and the composition was melt-extruded at 180° C. and 30 rpm, thereby preparing masterbatch chips of Preparation Example 1.

### Preparation Example 2

Masterbatch chips were prepared in the same manner as that of Preparation Example 1, except that the same amount of a sodium-neutralized ethylene acrylic acid ionomer (acrylic acid: 13.5 wt %, a degree of neutralization with sodium: 31 mol %) was used instead of the zinc-neutralized ethylene acrylic acid ionomer.

### Preparation of Ionomer Composition

### Example 1

A composition containing 900 g of a sodium-neutralized ethylene acrylic acid ionomer (acrylic acid: 13.5 wt %, a degree of neutralization of sodium: 31 mol %) and 100 g of the masterbatch of Preparation Example 1 was added to a T-die single-screw reaction extruder, and the composition was melt-extruded at 230° C. and 30 rpm, thereby producing an ionomer film having a thickness of about 1 mm. In addition, an ionomer strand was produced by the same extrusion process by changing a die of a discharge port of the extruder from a T-die to a circular hole die.

### Comparative Example 1

A composition containing 1,000 g of a zinc-neutralized ethylene acrylic acid ionomer (acrylic acid: 13.5 wt %, a degree of neutralization with zinc: 15 mol %) and 1 g of 3-aminopropyldiethoxymethylsilane was added to a single-screw reaction extruder, and the composition was melt-extruded at 230° C. and 30 rpm, thereby producing an ionomer film having a thickness of about 1 mm. In addition, an ionomer strand was produced by the same extrusion process as that of Example 1.

### Comparative Example 2

An ionomer film and an ionomer strand were produced in the same manner as that of Example 1, except that the same amount of the masterbatch of Preparation Example 2 was used instead of the masterbatch of Preparation Example 1.

### Comparative Example 3

An ionomer film and an ionomer strand were produced in the same manner as that of Comparative Example 1, except that a composition containing 900 g of a sodium-neutralized ethylene acrylic acid ionomer, 100 g of a zinc-neutralized ethylene acrylic acid ionomer, and 1 g of 3-aminopropyldiethoxymethylsilane was used.

The melt flow indices of the ionomer compositions, the hazes and adhesive strengths of the ionomer films, and the surfaces of the ionomer strands according to Example 1 and Comparative Examples 1 to 3 were measured. The results are shown in Table 1.

In addition, the surface of the ionomer strand was evaluated by touch according to a degree of roughness of the surface as poor (the case where the degree of roughness was significantly felt), good (the case where the degree of roughness was weakly felt), or excellent (the case where degree of roughness was barely felt).

TABLE 1

| | | Comparative | Comparative | Comparative |
|---|---|---|---|---|
| | Example 1 | Example 1 | Example 2 | Example 3 |
| Melt flow index | 1.21 | 6.3 | 0.89 | 0.81 |
| (g/10 min.) | | | | |
| Haze (%) | 0.52 | 0.79 | 0.68 | 0.75 |
| Adhesive strength | 77.9 | 78.6 | 51.3 | 67.2 |
| (N/cm) | | | | |
| Strand surface | Excellent | Good | Poor | Poor |

As shown in Table 1, when an ionomer composition was prepared by first preparing a masterbatch containing a zinc ionomer as a carrier resin of a coupling agent, and then adding the masterbatch to a sodium ionomer, the ionomer composition had an excellent melt flow index, and an ionomer film obtained using the same had an excellent adhesive strength to glass and a low haze value.

In particular, all of the haze values measured in Comparative Examples 1 to 3 were higher than that of Example due to an excessive crosslinking reaction, an excessively high melt flow index was measured in Comparative Example 1, and a low adhesive strength and a poor strand surface were measured in Comparative Examples 2 and 3. It was confirmed that these ionomer compositions of Comparative Examples were limited to be used in an intermediate layer of laminated glass, a solar cell encapsulation layer, and a transparent material requiring transparency, but the masterbatch described above was used in the ionomer composition according to some examples, such that an excellent adhesive strength to glass, a low haze, and excellent moldability were realized.

The present disclosure relates to a sodium ionomer composition having an excellent adhesive strength to glass, and a masterbatch obtained by melt-kneading a zinc ionomer and a coupling agent is used, such that a crosslinking side reaction, which has been a problem in the related art, may be effectively suppressed. Therefore, the ionomer composition has an effect of significantly improving transparency, processability, and/or an adhesive strength to glass in comparison to the related art.

Hereinabove, although the present disclosure has been described by specific matters and limited exemplary embodiments, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to the described exemplary embodiments, but the claims and all modifications equal or equivalent to the claims are intended to fall within the spirit of the present disclosure.

What is claimed is:

1. An ionomer composition comprising:
a sodium ionomer; and
a masterbatch comprising a zinc ionomer and a coupling agent,
wherein the sodium ionomer is comprised in a higher content than the zinc ionomer.

2. The ionomer composition of claim 1, wherein the sodium ionomer and the zinc ionomer are each independently an ethylene-(meth)acrylic acid ionomer.

3. The ionomer composition of claim 1, wherein the zinc ionomer has a degree of neutralization with zinc metal of 5 to 50 mol %.

4. The ionomer composition of claim 1, wherein the sodium ionomer has a degree of neutralization with sodium metal of 10 to 60 mol %.

5. The ionomer composition of claim 1, wherein a weight ratio of the sodium ionomer to the zinc ionomer is 4 to 20:1.

6. The ionomer composition of claim 1, wherein the coupling agent comprises an alkoxysilane-based compound.

7. The ionomer composition of claim 6, wherein the alkoxysilane-based compound comprises an amino group and a C₁₋₅ alkoxy group.

8. The ionomer composition of claim 6, wherein the alkoxysilane-based compound is one or a combination of two or more selected from aminopropyldimethoxymethylsilane, aminopropyldiethoxymethylsilane, aminopropyldimethoxyethylsilane, aminopropyldiethoxyethylsilane, aminopropyldimethoxypropylsilane, and aminopropyldiethoxypropylsilane.

9. The ionomer composition of claim 1, wherein the coupling agent is comprised in an amount of 0.1 to 5 parts by weight with respect to 100 parts by weight of the zinc ionomer.

10. The ionomer composition of claim 1, wherein the masterbatch is comprised in an amount of 5 to 30 parts by weight with respect to 100 parts by weight of the sodium ionomer.

11. The ionomer composition of claim 1, wherein the ionomer composition has a melt flow index of 0.5 to 10 g/10 min. when measured at a temperature of 190° C. and a load of 2.16 kg according to ASTM D1238.

12. The ionomer composition of claim 1, wherein the ionomer composition is used for an intermediate layer of laminated glass.

13. The ionomer composition of claim 1, wherein the ionomer composition has an adhesive strength to glass of 50 N/cm or more when measured at a thickness of 1 mm.

14. The ionomer composition of claim 1, wherein when the ionomer composition is in a form of a film having a thickness of 1 mm, the ionomer composition has a haze of 0.7% or less when measured according to ASTM D1003.

15. A glass laminate comprising:
a first glass;
an intermediate layer provided on the first glass and formed using the ionomer composition of claim 1; and
a second glass provided on the intermediate layer.

16. A method of preparing an ionomer composition, comprising the steps of:
(a) preparing a masterbatch by melt-kneading a composition comprising a zinc ionomer and a coupling agent; and
(b) melt-kneading a sodium ionomer and the masterbatch.

17. The method of claim 16, wherein in the step (a), the masterbatch is in a state in which the coupling agent is uniformly dispersed inside the zinc ionomer.

18. The method of claim 16, wherein a melt-kneading temperature in the step (a) is lower than a melt-kneading temperature in step (b).
